(19) United States
(12) Patent Application Publication
(10) Pub. No.: US 2013/0057003 A1
(43) Pub. Date: Mar. 7, 2013

(54) MAGNETIC LIFTING TOOL

(71) Applicant: Benjamin J. Watson, Concord, CA (US)

(72) Inventor: Benjamin J. Watson, Concord, CA (US)

(21) Appl. No.: 13/567,026

(22) Filed: Aug. 4, 2012

Related U.S. Application Data
(60) Provisional application No. 61/529,924, filed on Sep. 1, 2011.

(51) Int. Cl. B25J 15/06; H01F 7/00

(52) U.S. Cl. 294/65.5

(57) ABSTRACT

A spring-loaded pin-guided magnetic tool which is particularly well adapted for the lifting of hydraulic valve lifters from their bores in an OHV engine. An elongated tube has a magnet affixed to one end and is inserted into the engine block. The magnet is guided into place with spring-loaded, retractable guide pin. By extending the guide pin into the bore and guiding it into a recess on the top of a valve, the magnet can be placed very close to the center of the lifter. The placement of the magnet improves the precision of the tool because a user can be reasonably certain the magnet end of the tool is located at the bottom of a recess in a lifter. An collar is positioned along the tube allowing it to rest against the head and hold the magnetic end of the tool at a proper height.

### PRIORITY

This application claims the benefit of U.S. Provisional Patent Application number 61/529,924 filed Sep. 1, 2011 by the same inventor entitled “Magnetic Lifting Tool” which is hereby incorporated by reference as if fully set forth herein.

### BACKGROUND

Conventional automotive and truck engines are constructed with a valve actuating camshaft located in a bore in an engine block. Typically, these engines use the overhead valve principle, with the valves being actuated by pushrods extending upwardly from the camshaft lobes and acting on rocker arms atop the cylinder head to actuate the valves. Originally lifters were of mechanical (solid) design that required the maintenance of proper clearances in the valve train to accommodate expansion of the components when heated during normal engine operation. Modern engines also use hydraulic (or tappets), flat, and roller lifters. The lifters ride on the cam lobes to actuate the valve pushrods. The hydraulic lifter was designed to ensure that the valve train always operates with zero clearance, leading to quieter operation and eliminating the need for periodic adjustment of valve clearance.

The hydraulic lifter may consist of a hollow expanding piston situated between the camshaft and valve. It is operated either by a rocker mechanism, or for overhead camshafts, directly by the camshaft. Often the lifter is filled with engine oil intermittently from an oil gallery via a small opening. When the engine valve is closed, the lifter is free to fill with oil. When the valve is opening and the lifter is being operated by the camshaft, the oil feed is blocked and the lifter acts just as a solid one would, oil being incompressible.

From time to time it is generally necessary to remove the camshaft from the engine to effectuate repairs or improvements. Conventionally the labor required for such a job was relatively extensive because of the need to remove the cylinder head(s) in order to access the lifters before removing the camshaft. If the lifters are not removed the lifters will drop down past the cam lobes and bearings when the camshaft is removed. As the camshaft continues to be withdrawn, the succeeding cam lobe or bearing encounters the dropped lifter from the adjacent valve in the adjacent cylinder, which blocks further withdrawal of the camshaft from the block. Conventionally a mechanic is required to spend the additional time and labor to remove the cylinder head(s) from the engine to gain access to the lifter bores, and then remove the lifters from their bores.

### SUMMARY

Disclosed herein is a solution to the above problem in the form of a spring-loaded pin-guided magnetic tool which is particularly well adapted for the lifting of hydraulic valve lifters from their bores in an overhead valve (OHV) gasoline or diesel engine. An elongated tube has a magnet affixed to one end and is inserted into the engine block. The magnet is guided into place with spring-loaded, retractable guide pin. By extending the guide pin into the bore and guiding it into a recess on the top of a valve, the magnet can be placed very close to the center of the lifter. The tube has indicia indicating depth of the bore. The precise placement of the magnet improves the precision of the tool because a user can be reasonably certain the magnet end of the tool is located at (or close to) the bottom of a recess in a lifter.

An adjustable collar is positioned along the shank of the tube allowing the tube to rest against the head and hold the magnetic end of the tool at a sufficient height to maintain the lifter clear of the cam lobes.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 illustrates an embodiment of a magnetic lifting tool.

FIG. 2 shows an embodiment of a magnetic lifting tool.

### DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### DETAILED DESCRIPTION

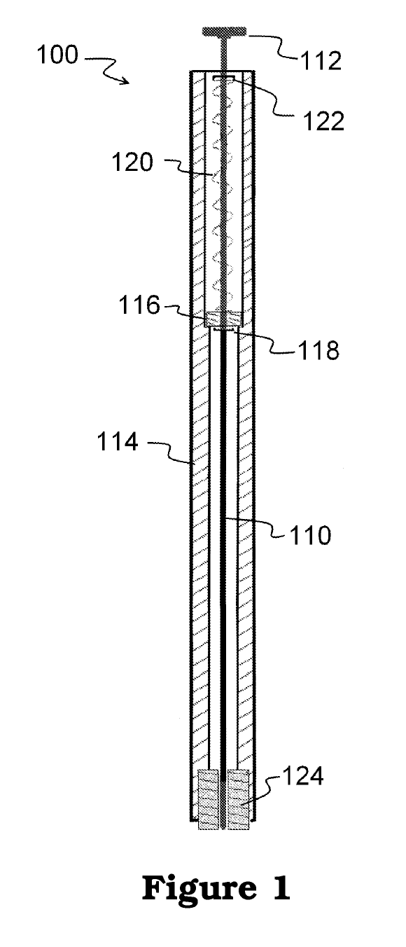

FIG. 1 illustrates a first embodiment of a magnetic lifting tool 100. In FIG. 1 a guide pin 110 has a knurled knob 112 affixed to one end. The guide pin 110 is disposed in a cylindrical tube 114 such that the guide pin 110 extends completely through the tube 114. The guide pin 110 has threading at the top end for attaching the knurled knob 112. The guide pin 110 may be tapered (not shown) at the end opposite the knurled knob 112.

A bushing 116 is inserted into the tube 114. The tube 114 may have multiple inner diameters to allow for receiving the bushing 116 and securing it in place. The bushing 116 is sized to compress against the inner diameter of the tube 114 thus keeping it secure. Attached to the guide pin 110 is a lower retainer (or “push nut”) 118. The lower retainer 118 acts to keep the guide pin 110 from sliding past the bushing 116.

As shown in FIG. 1 the cylindrical tube 114 may have two different interior diameters, however, one have skill in the art will recognize that the inner diameter of the tube need not be effectuated this way. In addition, while the inventor contemplates making the tube 114 from aluminum, the tube 114 may be made from any material capable of holding the necessary components and operating appropriately. Similarly, other components such as the guide pin 110 and retainers may also be manufactured from a variety of materials.

A spring 120 is placed around the guide pin 110 and positioned to abut the bushing 116 on the side of the bushing 116 opposite the lower retainer 118. An upper retainer 122 is placed around the guide pin 110 and positioned to retain the spring over a portion of the guide pin 110. In some embodiments the retainer 122 may be held in place by tapering the tube 114 at the end closest to the retainer 122.

A magnet 124 is placed in the lower end of the tube 114. The magnet 124 may extend slightingly beyond the edge of the tube 114. The magnet 124 has a hole through the center and the guide pin 110 is aligned to pass through the center of the magnet 124. The magnet 124 may be disposed inside the tube 114 or attached on to the end of the tube 114. The size of the magnet 124 may be determined based on the expected carrying capacity of the tool.

In operation, a user would push the knob 112 thus extending the guide pin 110 out the bottom of the tube 114. In pushing the guide pin 110, the spring 120 will be depressed between the bushing 116 and the upper retainer 122. When the user releases the knob 112, the force of the spring retracts the guide pin 100 back into the tube 114. One having skill in the art will appreciate that the lengths of the spring 120, guide pin 110, and tube 114 operate together to determine the length of extension of the guide pin 110 from the bottom of the tube 114.

One having skill in the art will recognize that the shaft 114 may be formed using two shafts, an inner and an outer shaft. If the inner shaft is cut to the correct length, it may provide for a lip to hold bushing 116 and a lip to hold the magnet 124.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

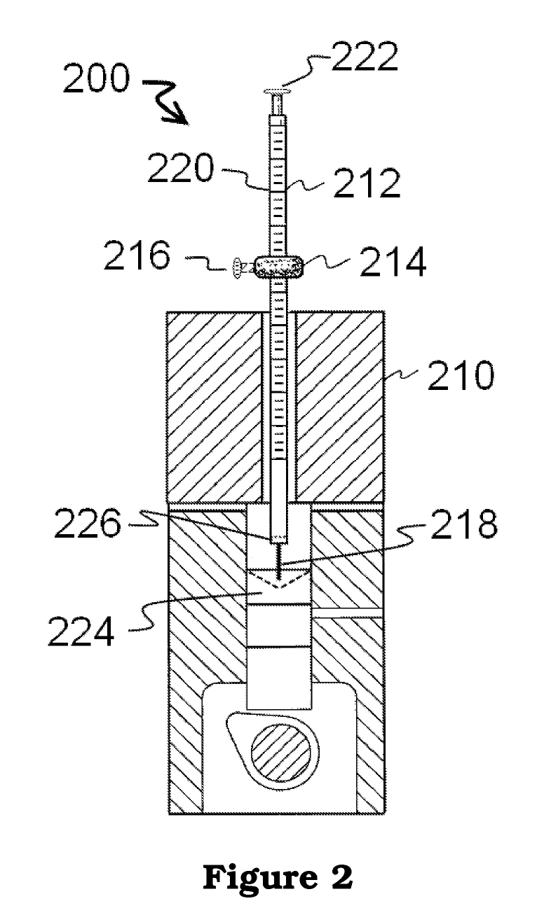

FIG. 2 shows an alternate embodiment of a magnetic lifting tool 200. In FIG. 2 the tool 200 is shown in a cut-away perspective view of an engine block 210. The tool 200 has indicia 212 along the edge allowing a user to know the depth of the tool when it is inserted into the engine block 210. The indicia may be displayed with one or more standard measurement units such as inches or centimeters. A stop-collar 214 is placed around the central shaft 220 of the tool 200 and may be locked onto the shaft 220 using a threaded set screw 216 (shown in the figure with a knurled knob for easy adjustment).

A guide pin 218 is shown partially extended from the bottom of the tool 200. The guide pin 218 is fed from a bore in the center of the shaft 220. At the opposite end of the shaft 220 there is a push-button control 222 coupled to the guide pin 218. By operating the push-button control 222, a user may extend the guide pin 218 beyond the end of the shaft 220. At the end of the shaft 220 is a magnet 226 attached to the shaft 220 such the guide pin extends from the center of the shaft 220. The magnet 226 is positioned such that the magnetic field affects the outer edge of the shaft 220 and the surrounding area.

The engine block 210 encloses a lifter 224. Conventional lifters have a concave recess (or indentation) on one surface as shown by the dotted lines in FIG. 2. In operation, the user extends the guide pin 218 beyond the end of the shaft 220 and into the recess on the lifter 224. While the guide pin 218 is extended and positioned into the recess, the tool 200 may be lowered down through the engine block 210 such that the guide pin 218 enters into the recess of the lifter 224. Once lowered in place, a user gently releases the guide pin 218 while pushing the tool 200 further down into the engine block 210. When the tool 200 is inserted as far as it will go, the magnet 226 will be located substantially about the center of the recess and will adhere to the lifter using magnetic force.

During the insertion process the guide pin 218 acts to prevent the lifter from being forced up to the magnet 226 because the guide pin 218 forces the lifter 224 away. The guide pin 218 also prevents the magnet 226 from moving laterally and attaching to the sides of the recess on the lifter 224. Thus, the diameter of the tool 200 does not affect positioning of the magnet on the lifter 224. The use of the guide pin 218 for positioning the magnet area into the recess allows for more accurate positioning of the magnetic lifter tool 200 on the lifter 224. With the magnet positioned into the recess, the user is reasonably assured of the tool's position, thus the depth indicia 212 is more accurate and positioning the tool 200 (or similar tools) may be done repetitively for each cylinder in the engine. Once the tool 200 is positioned at the appropriate height, the stop-collar 214 may be tightened in place using the set screw 216.

To remove the tool 200, a user extends the guide pin 218 by operating the push-button 222 thus separating the magnet 226 from the lifter 224 by breaking the magnetic hold on the lifter 224 and releasing the tool 200. One having skill in the art will recognize that the strength of the magnet and the strength and length of the guide pin are determined by the intended operation of the magnetic tool 200.

In operation, the tool 200 may be applied in each pushrod passage to hold all of the lifters simultaneously during camshaft removal and installation. One having skill in the art will recognize that the tool 200 may be modified to provide other functions as well, by forming a square, hexagonal, or other shaped receptacle at the magnetic end to grip a square drive socket, an interchangeable tool bit, or other component as desired.

The guide pin 218 may be constructed from a hollow tube (not shown). A hollow tube of sufficient diameter allows for liquids such as oil to be injected down the tube and on to the lifter thus allowing the valve to be properly oiled before starting the engine.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

I claim:

1. A device comprising:
a hollow shaft, said shaft including a magnet disposed about a first end of the shaft, said magnet having a through passage substantially near the center of the shaft;
a spring-loaded guide pin disposed within the shaft, said guide pin extending in part through the first and of the shaft and in part through a second end of the shaft;
an actuator, said actuator coupled to the guide pin and dispose towards the second end of the shaft;
wherein operating the actuator extends the guide pin through the passageway.

2. The device of claim 1 wherein said spring is secured in the shaft using a bushing and a retainer, said retainer affixed to the guide pin;

3. The device of claim 1 further including an adjustable stop-collar disposed about the shaft.

4. The device of claim 1 further including indicia disposed on the shaft.

5. The device of claim 1 wherein a portion of the magnet is disposed within the shaft.

6. A device comprising:
a hollow shaft;
a magnet secured at a first end of the hollow shaft, said magnet have a through hole substantially at the center of the shaft;
a guide pin disposed inside the shaft;
a bushing disposed inside the shaft;
a spring, said spring disposed within the shaft and having a first end abutting the bushing;
a retainer, said retainer secured to the guide pin and abutting the spring, and a knurled knob attached to the guide pin opposite the magnet.

7. The device of claim 6 further including an adjustable stop-collar disposed about the guide pin.

8. The device of claim 6 further including indicia disposed on the shaft.

9. The device of claim 6 wherein the shaft is tapered at the end opposite the guide pin.
